(19) United States
(12) Patent Application Publication
(10) Pub. No.: US 2026/0211968 A1
(43) Pub. Date: Jul. 23, 2026

(54) DATA PROCESSING DEVICE, DATA PROCESSING METHOD, AND DATA PROCESSING PROGRAM

(71) Applicant: NTT, Inc., Tokyo (JP)

(72) Inventors: Yusuke HORISHITA, Musashino-shi, Tokyo (JP); Yuya OMORI, Musashino-shi, Tokyo (JP); Ken NAKAMURA, Musashino-shi, Tokyo (JP); Daisuke KOBAYASHI, Musashino-shi, Tokyo (JP); Hiroyuki UZAWA, Musashino-shi, Tokyo (JP); Saki HATTA, Musashino-shi, Tokyo (JP); Shuhei YOSHIDA, Musashino-shi, Tokyo (JP); Yuko IINUMA, Musashino-shi, Tokyo (JP)

(73) Assignee: NIPPON TELEGRAPH AND TELEPHONE CORPORATION, Tokyo (JP)

(21) Appl. No.: 19/139,896

(22) PCT Filed: Jan. 18, 2023
(86) PCT No.: PCT/JP2023/001378

§ 371 Date: Jun. 17, 2025

(51) Int. Cl. G06F 17/15

(52) U.S. Cl. CPC G06F 17/153

(57) ABSTRACT

A data processing device that includes a neural network including convolution processing using a Winograd algorithm includes an acquisition unit that acquires target data to be processed, and a processing unit that processes the target data using the neural network including the convolution processing. The processing unit calculates a Hadamard product of a result of kernel transformation processing based on the Winograd algorithm and a kernel transformation matrix when performing the convolution processing, and obtains a result of the convolution processing by using a calculation result of the Hadamard product, and values of elements of the kernel transformation matrix are powers of 2 and have different constant values corresponding to divisors of division required for the kernel transformation processing when the kernel transformation matrix is not applied, and are set such that no division is included in the operation processing before the multiplication is executed.

### TECHNICAL FIELD

The technology of the disclosure relates to a data processing device, a data processing method, and a data processing program.

### BACKGROUND ART

Demands for deep learning are increasing and expected to be applied to various fields such as autonomous driving, surveillance, and monitoring. In particular, in recent years, accelerators, which are dedicated hardware, have been actively developed to enable large-scale computational processing of deep learning within edge terminals such as cameras. An accelerator described in NPL 1 aims to reduce the amount of data and the amount of calculation by limiting data handled in convolution operation processing of deep learning to 8-bit fixed-point data and using the Winograd algorithm.

### CITATION LIST

### Non Patent Literature

[NPL 1] S. Kala, B. R. Jose, J. Mathew and S. Nalesh, “High-Performance CNN Accelerator on FPGA Using Unified Winograd-GEMM Architecture,” in IEEE Transactions on Very Large Scale Integration (VLSI) Systems, vol. 27, no. 12, pp. 2816-2828 December 2019, doi: 10.1109/TVLSI.2019.2941250.

### SUMMARY OF INVENTION

### Technical Problem

In order to apply the Winograd algorithm to convolution operations, transformation processing for various data is required to be performed before and after multiplication. In order to realize the transformation processing for various data by hardware, additional resources such as an adder and a divider (or a shifter) are required. Accelerators, which are hardware dedicated to deep learning, are generally designed to have a high degree of parallelism in a convolution operation unit to improve a throughput. Thus, even when each of the additional resources required for this transformation processing is small, there is a concern that there may be an impact on resources of the entire system depending on the degree of parallelism of the convolution operation unit.

The disclosed technology has been made in view of the above-described circumstances, and an object thereof is to provide a data processing device, a data processing method, and a data processing program which are capable of reducing a circuit size while maintaining the accuracy of operation in a convolution operation using the Winograd algorithm.

### Solution to Problem

A first aspect of the present disclosure is a data processing device that includes a neural network including convolution processing using a Winograd algorithm, the data processing device including an acquisition unit that acquires target data to be processed, and a processing unit that processes the target data using the neural network including the convolution processing, in which the processing unit calculates a Hadamard product of a result of kernel transformation processing based on the Winograd algorithm and a kernel transformation matrix when performing the convolution processing, and obtains a result of the convolution processing by using a calculation result of the Hadamard product for multiplication, and values of elements of the kernel transformation matrix are powers of 2 and have different constant values corresponding to divisors of division required for the kernel transformation processing when the kernel transformation matrix is not applied, and are set such that no division is included in the operation processing before the multiplication is executed.

A second aspect of the present disclosure is a data processing method in a data processing device that includes a neural network including convolution processing using a Winograd algorithm, the data processing method including acquiring target data to be processed by an acquisition unit, processing the target data using the neural network including the convolution processing by a processing unit, in which the processing unit calculates a Hadamard product of a result of kernel transformation processing based on the Winograd algorithm and a kernel transformation matrix when performing the convolution processing, and obtains a result of the convolution processing by using a calculation result of the Hadamard product for multiplication, and values of elements of the kernel transformation matrix are powers of 2 and have different constant values corresponding to divisors of division required for the kernel transformation processing when the kernel transformation matrix is not applied, and are set such that no division is included in the operation processing before the multiplication is executed.

A third aspect of the present disclosure is a data processing program causing a computer that includes a neural network including convolution processing using a Winograd algorithm to acquire target data to be processed, and process the target data using the neural network including the convolution processing, in which a Hadamard product of a result of kernel transformation processing based on the Winograd algorithm and a kernel transformation matrix is calculated when performing the convolution processing, and a result of the convolution processing is obtained by using a calculation result of the Hadamard product for multiplication, and values of elements of the kernel transformation matrix are powers of 2 and have different constant values corresponding to divisors of division required for the kernel transformation processing when the kernel transformation matrix is not applied, and are set such that no division is included in the operation processing before the multiplication is executed.

### Advantageous Effects of Invention

According to the disclosed technology, it is possible to reduce a circuit size while maintaining the accuracy of operation in a convolution operation using the Winograd algorithm.

### BRIEF DESCRIPTION OF DRAWINGS

FIG. 1 is a schematic block diagram of an example of a computer that functions as a data processing device of this embodiment.

FIG. 2 is a diagram showing an example of a layer structure of a convolutional neural network.

FIG. 3 is a block diagram showing an example of a hardware configuration of an accelerator according to this embodiment.

FIG. 4 is a block diagram showing an example of a hardware configuration of a PE of the accelerator in this embodiment.

FIG. 5 is a diagram showing an example of a hardware configuration and a data flow of a MAC operation unit of the accelerator in this embodiment.

FIG. 6(a) is a diagram showing a feature map after Winograd pre-transformation processing in a comparative example and how a kernel is multiplied, and FIG. 6(a) is a diagram showing a feature map after Winograd pre-transformation processing in this embodiment and how a kernel is multiplied.

FIG. 7 is a block diagram showing a functional configuration of a data processing device according to this embodiment.

FIG. 8 is a block diagram showing a functional configuration of a learning unit of the data processing device according to this embodiment.

FIG. 9 is a block diagram showing a functional configuration of an inference unit of the data processing device according to this embodiment.

FIG. 10 is a flowchart showing a flow of learning processing according to this embodiment.

FIG. 11 is a flowchart showing a flow of convolution processing in the learning processing and data processing according to this embodiment.

FIG. 12 is a flowchart showing a flow of data processing according to this embodiment.

### DESCRIPTION OF EMBODIMENTS

Hereinafter, examples of embodiments of the disclosed technology will be described with reference to the drawings. In the drawings, the same or equivalent constituent elements and portions are denoted by the same reference numerals. In addition, dimensional ratios in the drawings are exaggerated for convenience of description and may differ from actual ratios.

### Overview of Embodiment of Disclosed Technology

The disclosed technology reduces a circuit size required when applying the Winograd algorithm to convolution operation processing of low-bit fixed-point data, and reduces a generated error.

The Winograd algorithm is known as a method of reducing the number of multiplications required for convolution operation processing. In order to apply the Winograd algorithm, it is necessary to perform a predetermined transformation on input data and a kernel required for a convolution operation before multiplication is performed, as shown in the following equation (hereinafter referred to as a Winograd transformation). Here, when the Winograd transformation of a fixed-point kernel is realized by hardware, rounding processing (rounding off) and saturation processing are required before inputting the data to a multiplier (first method of the related art).

$$\text{?}$$

$$\text{?} \text{indicates text missing or illegible when filed}$$

As shown in the above equation, the Winograd transformation is performed to obtain a convolution kernel to be input to the multiplier.

In order to reduce rounding processing, a method of multiplying an entire kernel by a constant value so that rounding processing is not necessary and then inputting it to the multiplier is also conceivable (second method of the related art). For example, in the case of the Winograd transformation processing of F(2×2, 3×3), rounding processing can be reduced by multiplying the entire kernel by 4, as shown in the following equation.

$$\text{?}$$

$$\text{?} \text{indicates text missing or illegible when filed}$$

In the disclosed technology, a Winograd transformation equation is modified as shown below. A Hadamard product of a matrix with a constant value that differs for each element so that rounding processing is not required and a kernel after Winograd transformation is calculated and input to the multiplier. Since the value of each element of a matrix newly added to calculation processing is fixed at all times in accordance with a coefficient position of a kernel, it is possible to realize the value by a fixed shifter and realize the value while hardly increasing a hardware size as long as the value of the element is a power of 2.

$$\text{?}$$

$$\text{?} \text{indicates text missing or illegible when filed}$$

Compared to the above-described first method of the related art, it is possible to reduce the number of rounding circuits before the multiplier in the disclosed technology. When viewed in units of a 4×4 kernel matrix after Winograd transformation as described above, a total of 12 rounding circuits can be reduced.

Furthermore, compared to the above-described second method of the related art, it is possible to reduce a saturation processing circuit for some coefficients (for example, four coefficients) in the disclosed technology. Furthermore, for coefficients K′0 to K′4, K′7 to K′8, and K′11 to K′15, a constant value multiplied by a kernel is smaller than that in the above-described second method of the related art, making it possible to reduce errors caused by saturation processing. Focusing on K′0 as an example, in the above-described second method of the related art, an error of a maximum of 75% is likely to occur due to saturation processing (an error is ¼ of the original value), but this can be reduced to 0%.

<Configuration of Data Processing Device According to this Embodiment>

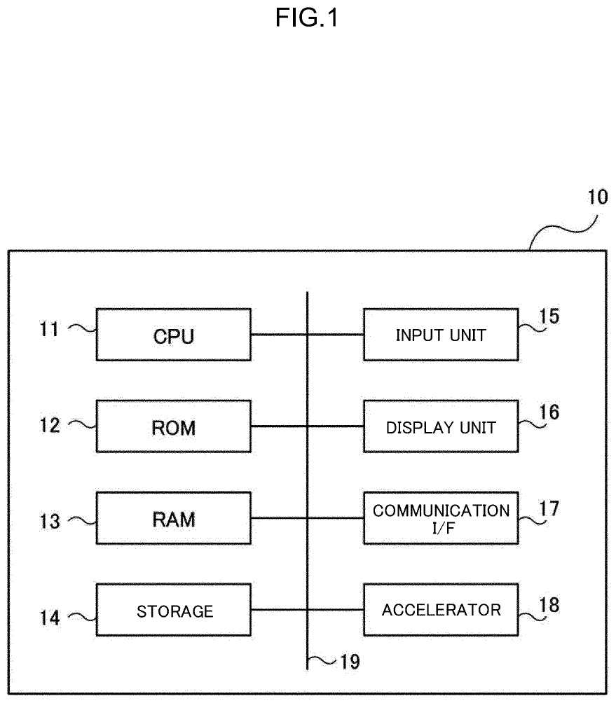

FIG. 1 is a block diagram showing the hardware configuration of a data processing device 10 according to this embodiment.

As shown in FIG. 1, the data processing device 10 includes a central processing unit (CPU) 11, a read only memory (ROM) 12, a RAM 13, a storage 14, an input unit 15, a display unit 16, a communication interface (I/F) 17, and an accelerator 18. The components are connected to each other via a bus 19 so as to be able to communicate with each other.

The CPU 11 is a central processing unit and executes various programs or controls each unit. That is, the CPU 11 reads out a program from the ROM 12 or the storage 14 and executes the program using the RAM 13 as a work area. The CPU 11 performs control of above-described each configuration and various types of arithmetic processing in accordance with the programs stored in the ROM 12 or the storage 14. In addition, the CPU 11 controls the execution timing of a camera module (not shown) and the accelerator 18 connected via the communication interface 17. In this embodiment, the ROM 12 or the storage 14 stores a learning processing program for performing learning processing of a neural network and a data processing program for performing data processing using the neural network. The learning processing program and the data processing program may be a single program, or may be a group of programs constituted by a plurality of programs or modules.

The ROM 12 stores various programs and various types of data. The RAM 13 temporarily stores the program or data as a work area. The storage 14 is constituted by a hard disk drive (HDD) or a solid state drive (SSD) and stores various programs including an operating system and various types of data.

The input unit 15 includes a pointing device such as a mouse and a keyboard, and is used to perform various inputs.

The input unit 15 receives learning data for learning the neural network as an input. For example, the input unit 15 receives, as an input, learning data including a target image to be processed and a processing result for the target image that has been obtained in advance.

Furthermore, the input unit 15 receives, as an input, a target image to be processed that has been captured by the camera module. The camera module is capable of capturing still images or videos at a predetermined frame rate, and the input unit 15 sequentially stores the captured images in the storage 14.

The display unit 16 is, for example, a liquid crystal display and displays various types of information including processing results. The display unit 16 may function as the input unit 15 by adopting a touch panel system.

The communication interface 17 is an interface for communicating with other devices, and uses, for example, standards such as Ethernet (registered trademark), FDDI, and Wi-Fi (registered trademark).

The accelerator 18 executes processing including convolution processing in a convolution layer of the neural network. Specifically, the accelerator 18 reads out a target image and a kernel stored in the storage 14, and executes processing (for example, object detection processing) including convolution processing by the neural network on the read target image.

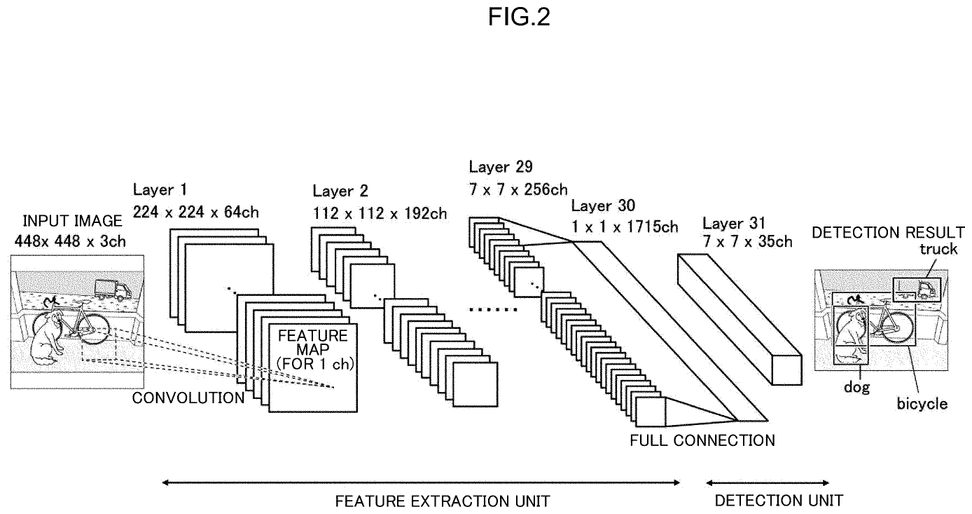

An example of the object detection processing executed by the accelerator 18 will be described with reference to FIG. 2. FIG. 2 shows an example of a layer structure of a convolutional neural network for realizing object detection processing. In the example shown in FIG. 2, an input image is an image with a width of 448 pixels and a height of 448 pixels, and including three color components of RGB. A feature extraction unit executes convolution operation processing using a plurality of kernels that differ in each layer, pooling operation processing, or the like on an input image to generate a feature map. Thereafter, a detection unit performs full connection on the feature map to generate data of a final layer. In the case of the object detection processing, the data of the final layer includes coordinate information indicating a relative position of an object with respect to the input image, the degree of reliability indicating whether an object is present at the coordinates, or a class classification probability indicating what class the object belongs to (for example, a person, a car, a dog, a cat, or the like). By referring to this information, the CPU 11 can detect what object is present in the input image and at what position the object is present, and can use this as a processing result. In this embodiment, it is assumed that individual feature values constituting a feature map and parameter values such as a kernel and a bias used during a convolution operation are 8-bit fixed-point data. Thereby, it is possible to significantly reduce the circuit size of the accelerator 18 and a required capacity of the storage 14 compared to the case of handling floating-point data such as 32 bits.

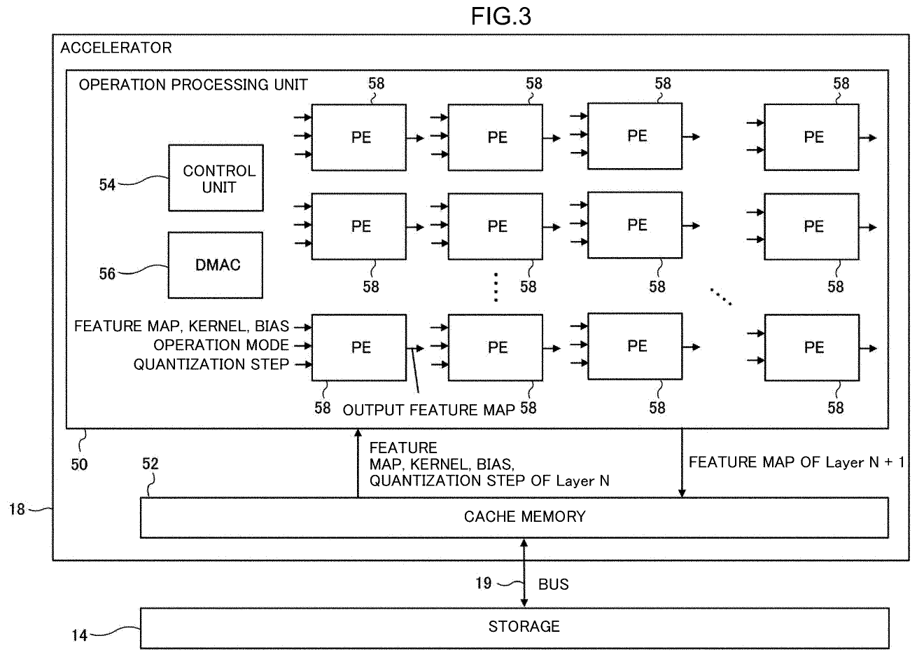

FIG. 3 is a block diagram showing an example of a hardware configuration of the accelerator 18 in this embodiment. The accelerator 18 includes an operation processing unit 50 and a cache memory 52, and the cache memory 52 is connected to the storage 14 via the bus 19. The cache memory 52 serves as a buffer located between the operation processing unit 50 and the storage 14, and plays a role in reducing a data transfer band between the operation processing unit 50 and the storage 14. The operation processing unit 50 includes a control unit 54, a direct memory access controller (DMAC) 56, and a plurality of processing engines (PEs) 58. The control unit 54 sets operation parameters for the DMAC 56 and the PEs 58, and manages data to be supplied to the PEs 58. The DMAC 56 reads out, from the cache memory 52, a feature map, parameters such as a kernel and a bias required for a convolution operation, and quantization step information for quantizing the feature map into 8-bit fixed-point data in accordance with the operation parameters set by the control unit 54. The read data is supplied to the PEs 58, and the PEs 58 executes operation processing in parallel. The feature map generated through the operation processing by the PEs 58 is stored in the cache memory 52 via the DMAC 56, and is read out from the cache memory 52 again when operation processing of the next layer is performed. Here, each of the PEs 58 has two operation modes, that is, a Winograd mode in which the Winograd algorithm is applied to a convolution operation, and a non-Winograd mode in which the Winograd algorithm is not applied. When the size of the kernel used in the convolution operation is 3×3 and a convolution application interval (stride) is 1, the control unit 54 performs setting so that each PE 58 operates in the Winograd mode. When the above-described condition is not satisfied, the control unit 54 performs setting so that each of the PEs 58 operates in the non-Winograd mode. In addition, when each of the PEs 58 operates in the Winograd mode, the DMAC 56 supplies each PE 58 with a feature map having a size of “width 4×height 4×number of input channels 1 (hereinafter referred to as 4×4)” and a kernel having a size of “width 3 ×height 3×number of input channels 1 (hereinafter referred to as 3×3)”. On the other hand, when each PE 58 operates in the non-Winograd mode, the DMAC 56 supplies each PE 58 with a feature map having a size of “width 1×height 1×number of input channels 4” and a kernel.

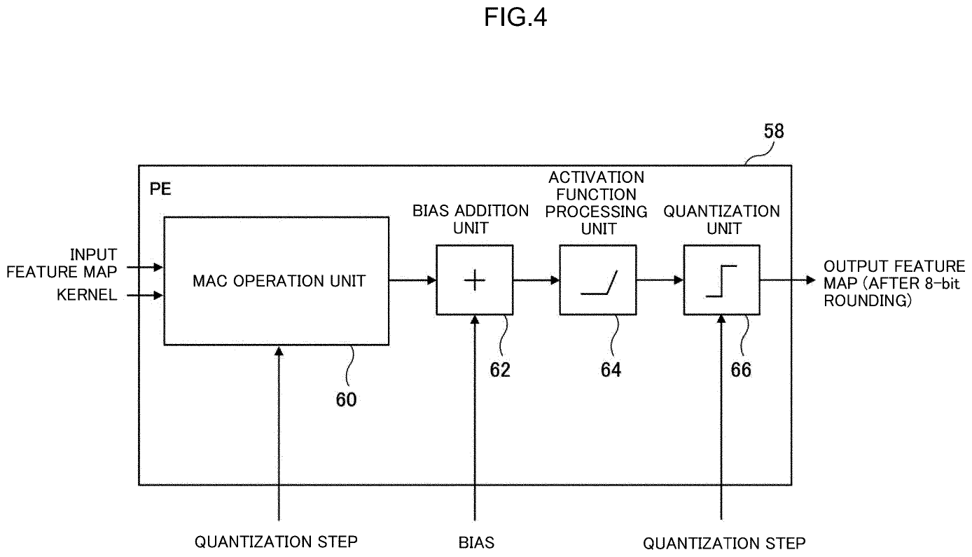

FIG. 4 is a block diagram showing an example of a hardware configuration of the PE 58. The MAC operation unit 60 executes a convolution operation using a feature map and a kernel. A convolution operation result is subjected to an operation by a bias addition unit 62 and an activation function processing unit 64, and is quantized to have a quantization step that is set by a quantization unit 66 and output.

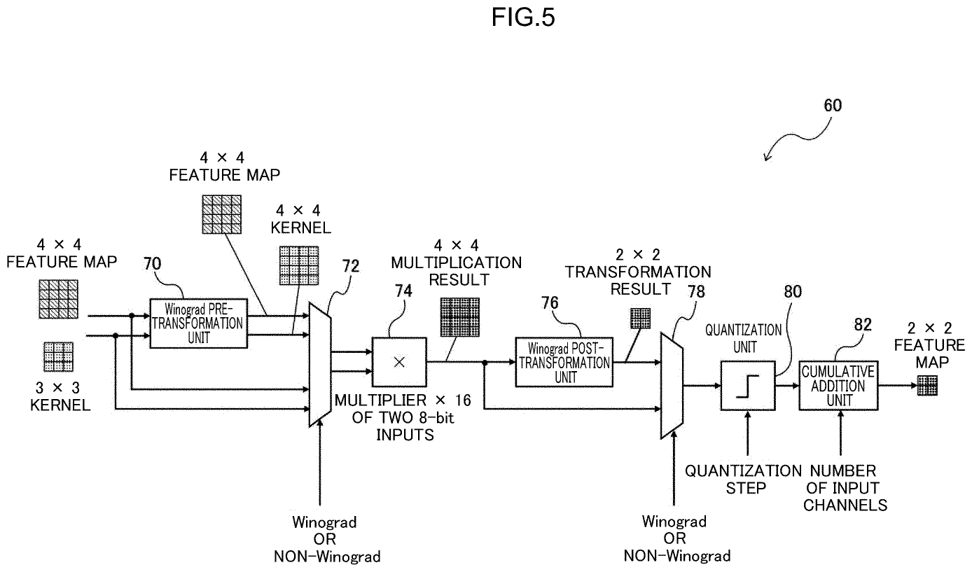

FIG. 5 is a diagram showing an example of a hardware configuration of the MAC operation unit 60 and a data flow. The MAC operation unit 60 includes two data paths, one for the Winograd mode and the other for the non-Winograd mode. FIG. 5 shows a data flow during an operation in the Winograd mode. During the operation in the Winograd mode, a 4×4 feature map and a 3×3 kernel are input to the MAC operation unit 60. These pieces of data are subjected to transformation processing by a Winograd pre-transformation unit 70, multiplication by a multiplier 74, transformation processing by a Winograd post-transformation unit 76, cumulative addition by a cumulative addition unit 82, and quantization by a quantization unit 80, and a 2×2 feature map is finally output. The multiplier 74 of the MAC operation unit 60 includes 16 circuits for multiplying two pieces of 8-bit fixed-point data. In the Winograd algorithm, calculation process for obtaining an m×m output using an r×r filter is generally denoted as F (m×m, r×r), and the MAC operation unit 60 can realize processing of F(2×2, 3×3). Here, processing for obtaining a matrix Y, which is a processing result of F(2×2, 3×3), can be written as follows.

$$Y = {A}^{T} [ U ⊙ V ] A = {A}^{T} [ {G}_{i} g {G}^{T} ⊙ {B}^{T} d B ] A$$

$$d = [ \begin{matrix}{i}_{0} & {i}_{1} & {i}_{2} & {i}_{3} \\ {i}_{4} & {i}_{5} & {i}_{6} & {i}_{7} \\ {i}_{8} & {i}_{9} & {i}_{10} & {i}_{11} \\ {i}_{12} & {i}_{13} & {i}_{14} & {i}_{15}\end{matrix} ]$$

$$g = [ \begin{matrix}{k}_{0} & {k}_{1} & {k}_{2} \\ {k}_{3} & {k}_{4} & {k}_{5} \\ {k}_{6} & {k}_{7} & {k}_{8}\end{matrix} ]$$

$${B}^{T} = [ \begin{matrix}1 & 0 & - 1 & 0 \\ 0 & 1 & 1 & 0 \\ 0 & - 1 & 1 & 0 \\ 0 & 1 & 0 & - 1\end{matrix} ]$$

$$G = [ \begin{matrix}1 & 0 & 0 \\ \frac{1}{2} & \frac{1}{2} & \frac{1}{2} \\ \frac{1}{2} & - \frac{1}{2} & \frac{1}{2} \\ 0 & 0 & 1\end{matrix} ]$$

$${A}^{T} = [ \begin{matrix}1 & 1 & 1 & 0 \\ 0 & 1 & - 1 & - 1\end{matrix} ]$$

A matrix d represents a 4×4 input feature map, and a matrix g represents a 3×3 input kernel. Furthermore, a matrix B represents a transformation matrix of the input feature map, a matrix G represents a transformation matrix of the input kernel, and
⊙
   represents element-by-element multiplication of a matrix (Hadamard product). Furthermore, a matrix A is a matrix for transforming a multiplication result again to obtain an output. Here, focusing on a result GgG^{T} of transformation processing for the kernel, the equation is transformed as follows.

$${GgG}^{T} = [ \begin{matrix}1 & 0 & 0 \\ \frac{1}{2} & \frac{1}{2} & \frac{1}{2} \\ \frac{1}{2} & - \frac{1}{2} & \frac{1}{2} \\ 0 & 0 & 1\end{matrix} ] [ \begin{matrix}{k}_{0} & {k}_{1} & {k}_{2} \\ {k}_{3} & {k}_{4} & {k}_{5} \\ {k}_{6} & {k}_{7} & {k}_{8}\end{matrix} ] [ \begin{matrix}1 & \frac{1}{2} & \frac{1}{2} & 0 \\ 0 & \frac{1}{2} & - \frac{1}{2} & 0 \\ 0 & \frac{1}{2} & \frac{1}{2} & 1\end{matrix} ] = [ \begin{matrix}{k}_{0} & \frac{{k}_{0} + {k}_{1} + {k}_{2}}{2} & \frac{{k}_{0} - {k}_{1} + {k}_{2}}{2} & {k}_{2} \\ \frac{{k}_{0} + {k}_{3} + {k}_{6}}{2} & \frac{{k}_{0} + {k}_{3} + {k}_{6} + {k}_{1} + {k}_{4} + {k}_{7} + {k}_{2} + {k}_{5} + {k}_{8}}{4} & \frac{{k}_{0} + {k}_{3} + {k}_{6} - {k}_{1} - {k}_{4} - {k}_{7} + {k}_{2} + {k}_{5} + {k}_{8}}{4} & \frac{{k}_{2} + {k}_{5} + {k}_{8}}{2} \\ \frac{{k}_{0} - {k}_{3} + {k}_{6}}{2} & \frac{{k}_{0} - {k}_{3} + {k}_{6} + {k}_{1} - {k}_{4} + {k}_{7} + {k}_{2} - {k}_{5} + {k}_{8}}{4} & \frac{{k}_{0} - {k}_{3} + {k}_{6} - {k}_{1} + {k}_{4} - {k}_{7} + {k}_{2} - {k}_{5} + {k}_{8}}{4} & \frac{{k}_{2} - {k}_{5} + {k}_{8}}{2} \\ {k}_{6} & \frac{{k}_{6} + {k}_{7} + {k}_{8}}{2} & \frac{{k}_{6} - {k}_{7} + {k}_{8}}{2} & {k}_{8}\end{matrix} ]$$

As shown in the above equation, the result GgG^{T} of the transformation processing for the kernel requires addition, subtraction, and division of a plurality of kernel coefficients. When this kernel transformation is realized by hardware, the following circuit resources are usually required.
1. 1-bit or 2-bit right shifter for executing division
2. Rounding processing circuit for rounding lower bits of division result by rounding-off or the like
3. Saturation processing circuit for ensuring that result of transformation processing for kernel is within range that can be expressed by number of input bits of multiplier (8 bits in this embodiment)

In this embodiment, the following modification is made to processing of F(2×2, 3×3) normally used in the Winograd algorithm by introducing a kernel transformation matrix C, a matrix D, and a coefficient α.

$$Y = {A}^{T} [ U ⊙ V ] A = {A}^{T} [ G g {G}^{T} ⊙ {B}^{T} dB ] A = α \times {A}^{T} [ D ⊙ C ⊙ {GgG}^{T} ⊙ {B}^{T} dB ] A$$

$$C = [ \begin{matrix}1 & 2 & 2 & 1 \\ 2 & 4 & 4 & 2 \\ 2 & 4 & 4 & 2 \\ 1 & 2 & 2 & 1\end{matrix} ]$$

$$d = [ \begin{matrix}4 & 2 & 2 & 4 \\ 2 & 1 & 1 & 2 \\ 2 & 1 & 1 & 2 \\ 4 & 2 & 2 & 4\end{matrix} ]$$

$$α = 1 / 4$$

The kernel transformation matrix C, the matrix D, and the coefficient α are set such that calculation results are equivalent to those of the algorithm before the modification, and element values and coefficient values of the matrices are powers of 2. In addition, the value of each element of the kernel transformation matrix C is a constant value indicating a divisor of division required for the kernel transformation processing (the result GgG^{T} of the kernel transformation processing) when the kernel transformation matrix C is not applied.

They are set such that no division is required in a calculation process for each element of

$$C ⊙ {GgG}^{T} .$$

In the above example, the values of the kernel transformation matrix C, the matrix D, and the coefficient α shown in this embodiment are merely examples, and as long as the above is satisfied, the values do not necessarily have to be those shown in this embodiment and can also be applied to the Winograd algorithm other than F (2×2, 3×3).

Operation processing performed by the Winograd pre-transformation unit 70 of this embodiment will be described. The Winograd pre-transformation unit 70 calculates a feature map transformation matrix B^{T}dB and a kernel transformation matrix

$$C ⊙ Gg {G}^{T} .$$

Since coefficients of elements of the kernel transformation matrix C are all powers of 2, a Hadamard product included in a calculation process of the matrix

$$C ⊙ Gg {G}^{T}$$

can be realized with a 1-bit or 2-bit left shifter and can be realized without increasing circuit resources. Here, when the matrix

$$C ⊙ Gg {G}^{T}$$

is obtained, it can be written as follows.

$$C ⊙ Gg {G}^{T} = [ \begin{matrix}\text{?} & \text{?} & \text{?} & \text{?} \\ \text{?} & \text{?} & \text{?} & \text{?} \\ \text{?} & \text{?} & \text{?} & \text{?} \\ \text{?} & \text{?} & \text{?} & \text{?}\end{matrix} ]$$

$$\text{?} \text{indicates text missing or illegible when filed}$$

From the above equation, the Winograd pre-transformation unit 70 eliminates the need for division by calculating the Hadamard product of the kernel transformation matrix C and the result GgG^{T} of the kernel transformation processing, making it possible to reduce circuit resources such as a rounding processing circuit for the lower bits required for the kernel transformation. When a 4×4 matrix is viewed as one unit as in the above equation, there are usually 12 elements per unit that require division, and thus a total of 12 rounding processing circuits can be reduced.

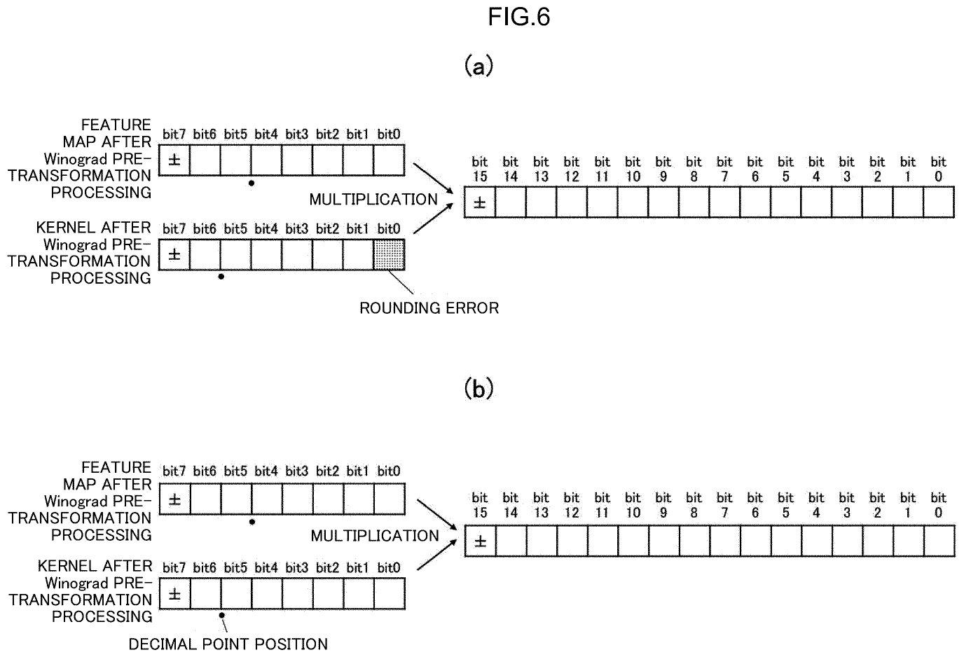

Here, the accuracy of operation for an F(2×2, 3×3) algorithm is considered using FIG. 6. FIG. 6 shows a feature map after Winograd pre-transformation processing and how a kernel is multiplied. FIG. 6(a) shows a comparative example in which division is required for Winograd pre-transformation processing, and a rounding error occurs in a least significant bit of a kernel input to the multiplier 74. Thus, the lower bits of a 16-bit multiplication result are affected by the rounding error. On the other hand, FIG. 6(b) shows a case where division is not required for Winograd pre-transformation processing as in this embodiment, and no rounding error occurs in a least significant bit of a kernel input to the multiplier 74. Thus, the lower bits of a 16-bit multiplication result are not affected by a rounding error, and the accuracy of operation is improved compared to when a normal algorithm is used.

Next, referring back to FIG. 5, the Winograd post-transformation unit 76 of this embodiment will be described. When a 4×4 multiplication result output from the multiplier 74 is represented as a matrix

$$R = [ C ⊙ {GgG}^{T} ⊙ {B}^{T} d B ] ,$$

the Winograd post-transformation unit 76 performs processing for applying the matrix D, the matrix A, and the coefficient α to the matrix R as follows. Specifically, the Hadamard product of the matrices D and R is calculated, and a 2×2 matrix is obtained by applying the matrix A to the front and back of the calculation result. Furthermore, a final 2×2 convolution operation result is obtained by multiplying all elements of the 2×2 matrix by the coefficient α.

$$Y = α \times {A}^{T} [ D ⊙ R ] A$$

Since the coefficients of the elements of the matrix D are all powers of 2, the multiplication of the Hadamard product of

$$D ⊙ R$$

can be realized by a 1-bit or 2-bit left shifter without increasing circuit resources. On the other hand, in this embodiment, it is necessary to divide each element of the 2×2 matrix by multiplying it by the coefficient α, which requires rounding processing for the lower bits. However, rounding the lower bits of the convolution operation result and quantizing it to 8 bits or the like is common in accelerators, which are hardware performing a convolution operation using fixed-point data, and is not unique to this embodiment. In addition, the division processing using the coefficient α does not necessarily have to be performed by the Winograd post-transformation unit 76, and it is also possible to perform the division together with quantization processing in the quantization unit 80 at a subsequent stage.

The convolution operation result output by the Winograd post-transformation unit 76 is quantized to 8 bits by the quantization unit 80 so as to have the quantization step that is set for each PE 58 and is stored in the cumulative addition unit 82. Thereafter, convolution operation results corresponding to the number of input channels which is set in advance are cumulatively added and output from the MAC operation unit 60.

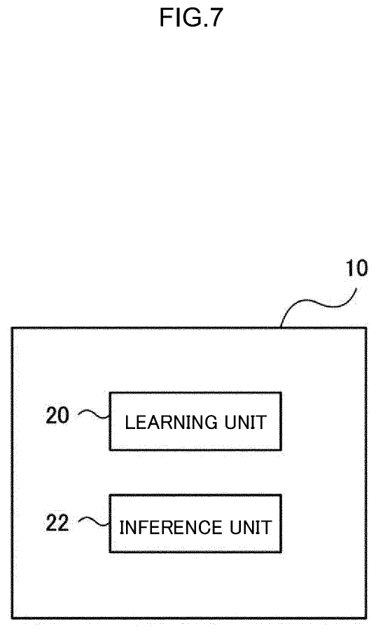

Next, a functional configuration of the data processing device 10 will be described. FIG. 7 is a block diagram showing an example of a functional configuration of the data processing device 10.

The data processing device 10 functionally includes a learning unit 20 and an inference unit 22, as shown in FIG. 7.

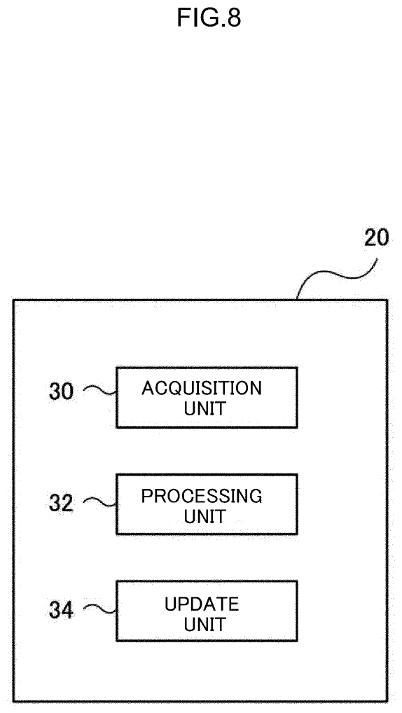

The learning unit 20 includes an acquisition unit 30, a processing unit 32, and an update unit 34, as shown in FIG. 8.

The acquisition unit 30 acquires a target image and a processing result of input learning data.

The processing unit 32 processes the target image of the learning data using a neural network including convolution processing using the Winograd algorithm. When performing the convolution processing, the processing unit 32 calculates the Hadamard product of the result of the kernel transformation processing based on the Winograd algorithm and the kernel transformation matrix, and obtains the result of the convolution processing by using a result of calculating the Hadamard product for multiplication. The processing using the neural network is executed using the accelerator 18. At this time, the target image and the kernel of the learning data are input to the accelerator 18, and the processing result is output from the accelerator 18.

Here, the values of the elements of the Kernel transformation matrix are powers of 2 and have different constant values corresponding to divisors of the division required for the kernel transformation processing when the Kernel transformation matrix is not applied, and are set such that no division is included in the operation processing before the multiplication is executed.

The calculation of the Hadamard product of the result of the kernel transformation processing based on the Winograd algorithm and the kernel transformation matrix is constituted by only a fixed shifter.

When performing the convolution processing, the accelerator 18 operates in a Winograd mode when the kernel of the corresponding layer has a specific size (for example, 3×3), and operates in a non-Winograd mode when the kernel of the corresponding layer does not have a specific size.

The update unit 34 updates the parameters of the neural network so that the result of processing the target image using the neural network matches a processing result obtained in advance.

Each processing of the processing unit 32 and the update unit 34 is repeatedly performed until a predetermined repetition end condition is satisfied. Thereby, the neural network is learned.

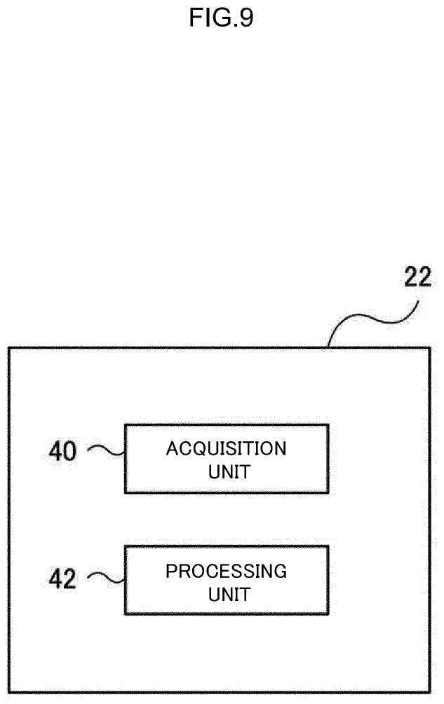

As shown in FIG. 9, the inference unit 22 includes an acquisition unit 40 and a processing unit 42.

The acquisition unit 40 acquires an input target image to be processed.

The processing unit 42 processes the target image using a neural network including convolution processing using the Winograd algorithm. When performing the convolution processing, the processing unit 42 calculates a Hadamard product of the result of the kernel transformation processing based on the Winograd algorithm and the kernel transformation matrix, and obtains the result of the convolution processing by using a result of calculating the Hadamard product for multiplication.

The processing using the neural network is executed using the accelerator 18. At this time, the target image and the kernel are input to the accelerator 18, and a processing result is output from the accelerator 18.

A result of processing the target image using the neural network is displayed on the display unit 16.

<Actions of Data Processing Device According to this Embodiment>

Next, actions of the data processing device 10 according to this embodiment will be described.

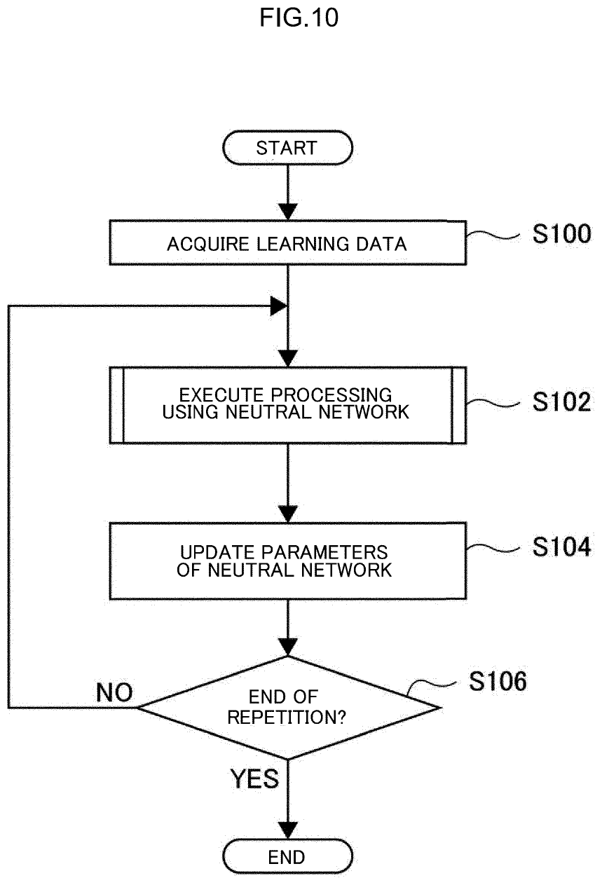

FIG. 10 is a flowchart showing a flow of learning processing performed by the data processing device 10. The learning processing is performed by the CPU 11 reading out a learning processing program from the ROM 12 or the storage 14, loading the program into the RAM 13, and executing the program. In addition, learning data is input to the data processing device 10. The learning processing is an example of a data processing method.

In step S100, the CPU 11 serves as the acquisition unit 30 to acquire a target image for which input learning data is to be processed, and a processing result.

In step S102, the CPU 11, which serves as the processing unit 32, uses the accelerator 18 to process the target image of the learning data by a neural network including convolution processing.

In step S104, CPU 11 serves as the update unit 34 to update the parameters of the neural network so that a result of processing the target image of the learning data using the neural network matches a processing result obtained in advance.

In step S106, the CPU 11 determines whether a predetermined repetition end condition is satisfied. When the repetition end condition is not satisfied, the CPU 11 returns to step S102 described above, and the processing of each of the processing unit 32 and the update unit 34 is repeatedly performed. Thereby, the neural network is learned.

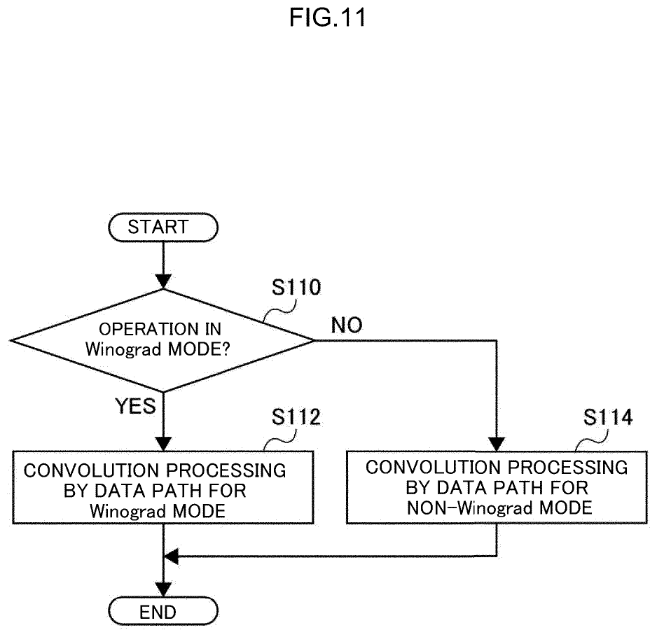

In step S102, operation processing is performed for each layer of the neural network. Here, the operation processing for a convolutional layer is realized by a processing routine shown in FIG. 11.

In step S110, the accelerator 18 serves as the processing unit 32 to determine whether to operate in a Winograd mode based on a kernel size of the convolutional layer. When it is determined that the accelerator 18 operates in the Winograd mode, the processing proceeds to step S112. On the other hand, when it is determined that the accelerator 18 does not operate in the Winograd mode, the processing proceeds to step S114.

In step S112, the accelerator 18 serves as the processing unit 32 to perform convolution processing using the above-mentioned data path for a Winograd mode shown in FIG. 5. At this time, selection units 72 and 78 select a Winograd mode.

In step S114, the accelerator 18 serves as the processing unit 32 to perform convolution processing using the above-mentioned data path for a non-Winograd mode shown in FIG. 5. At this time, the selection units 72 and 78 select a non-Winograd mode.

Then, the processing routine is ended, and a feature map is output and is used as an input feature map for the next layer.

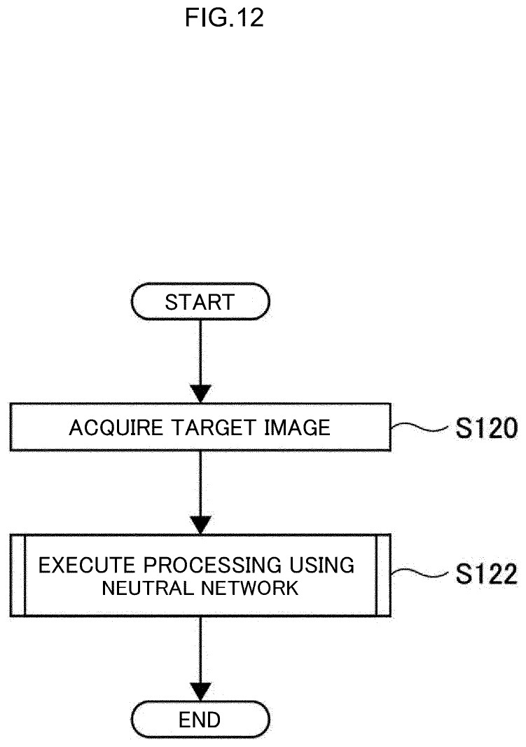

FIG. 12 is a flowchart showing a flow of data processing performed by the data processing device 10. The data processing is performed by the CPU 11 reading out a data processing program from the ROM 12 or the storage 14, loading the program into the RAM 13, and executing the program. In addition, a target image is input to the data processing device 10. The data processing is an example of a data processing method.

In step S120, the CPU 11 serves as the acquisition unit 40 to acquire an input target image.

In step S122, the CPU 11 serves as the processing unit 42 to process the target image by the neural network learned through the above-mentioned learning processing by using the accelerator 18. Then, a result of processing the target image using the neural network is displayed on the display unit 16.

In step S122, operation processing is performed for each layer of the neural network. Here, the operation processing for the convolutional layer is realized by the processing routine shown in FIG. 11.

As described above, when performing convolution processing, the data processing device of this embodiment calculates a Hadamard product of a result of kernel transformation processing based on the Winograd algorithm and a kernel transformation matrix, and obtains a result of the convolution processing by using a result of calculating the Hadamard product for multiplication. The values of the elements of the Kernel transformation matrix are powers of 2 and have different constant values corresponding to divisors of the division required for the kernel transformation processing when the Kernel transformation matrix is not applied, and are set such that no division is included in the operation processing before the multiplication is executed. Thereby, it is possible to reduce a circuit size while maintaining the accuracy of operation in a convolution operation using the Winograd algorithm.

The present invention is not limited to the device configuration and actions of the embodiment described above, and various modifications and applications can be made without departing from the gist of the present invention.

For example, although a case where data to be processed is an image has been described as an example, the present disclosure is not limited thereto, and the data may be data other than an image and may be, for example, sound data.

Further, a case where the data processing device includes the learning unit and the inference unit has been described as an example, but the present disclosure is not limited thereto. A device including the learning unit and a device including the inference unit may be configured as separate devices.

Furthermore, the learning unit may learn a neural network including normal convolution processing without using the Winograd algorithm.

In addition, a case where the specific kernel size when operating in a Winograd mode is 3×3 has been described, but the present disclosure is not limited thereto. The specific kernel size when operating in a Winograd mode may be 5×5 or 7×7. In this case, it is sufficient to perform implementation so that an operation is performed in a Winograd mode for a kernel size of 5×5 or 7×7.

Further, the various types of processing executed in a case where the CPU reads out software (program) in the above embodiment may be executed by various processors other than the CPU. Examples of processors used in such cases include a programmable logic device (PLD) such as a field-programmable gate array (FPGA) of which a circuit configuration can be changed after manufacturing and a dedicated electrical circuit that is a processor having a circuit configuration such as an application specific integrated circuit (ASIC) that is designed to execute specific processing. In addition, the learning processing and the data processing may be executed by one of these various processors, or may be executed by a combination of two or more processors of the same type or different types (for example, a plurality of FPGAs, a combination of a CPU and an FPGA, and the like). Further, more specifically, a hardware structure of these various processors is an electric circuit in which circuit elements such as semiconductor elements are combined.

Further, in each embodiment described above, the aspect in which the learning processing program and the data processing program are stored (installed) in advance in the storage 14 has been described, but the present disclosure is not limited thereto. The program may be provided in an aspect in which the program is stored in a non-transitory storage medium such as a compact disk read only memory (CD-ROM), a digital versatile disk read only memory (DVD-ROM), or a universal serial bus (USB) memory. Further, the program may be downloaded from an external device via a network.

Regarding the above embodiment, the following appendices are further disclosed.

### Appendix 1

A data processing device that includes a neural network including convolution processing using an Winograd algorithm, the data processing device including:
a memory; and
at least one processor connected to the memory, wherein
the processor is configured to
acquire target data to be processed, and
process the target data using the neural network including the convolution processing,
the processor calculates a Hadamard product of a result of kernel transformation processing based on the Winograd algorithm and a kernel transformation matrix when performing the convolution processing, and obtains a result of the convolution processing by using a calculation result of the Hadamard product for multiplication, and
values of elements of the kernel transformation matrix are powers of 2 and have different constant values corresponding to divisors of division required for the kernel transformation processing when the kernel transformation matrix is not applied.

### Appendix 2

A non-transitory storage medium storing a program executable by a computer including a neural network including convolution processing using a Winograd algorithm, wherein data processing includes
acquiring target data to be processed, and
processing the target data using the neural network including the convolution processing, the data processing includes calculating a Hadamard product of a result of kernel transformation processing based on the Winograd algorithm and a kernel transformation matrix when performing the convolution processing, and obtaining a result of the convolution processing by using a calculation result of the Hadamard product, and
values of elements of the kernel transformation matrix are powers of 2 and have different constant values corresponding to divisors of division required for the kernel transformation processing when the kernel transformation matrix is not applied.

### REFERENCE SIGNS LIST

10 Data processing device
11 CPU
13 RAM
18 Accelerator
20 Learning unit
22 Inference unit
30 Acquisition unit
32 Processing unit
34 Update unit
40 Acquisition unit
42 Processing unit
58 PE
70 Winograd pre-transformation unit
74 Multiplier
76 Winograd post-transformation unit

1. A data processing device that includes a neural network including convolution processing using a Winograd algorithm, the data processing device comprising:
a memory; and
at least one processor coupled to the memory, the at least one processor being configured to:
acquire target data to be processed; and
process the target data using the neural network including the convolution processing,
wherein the at least one processor calculates a Hadamard product of a result of kernel transformation processing based on the Winograd algorithm and a kernel transformation matrix when performing the convolution processing, and obtains a result of the convolution processing by using a calculation result of the Hadamard product for multiplication, and
wherein values of elements of the kernel transformation matrix are powers of 2 and have different constant values corresponding to divisors of division required for the kernel transformation processing when the kernel transformation matrix is not applied, and are set such that no division is included in the operation processing before the multiplication is executed.

2. The data processing device according to claim 1, wherein the values of the elements of the kernel transformation matrix are the divisors of the division required for the kernel transformation processing when the kernel transformation matrix is not applied.

3. The data processing device according to claim 1, wherein the calculation of the Hadamard product of the result of the kernel transformation processing based on the Winograd algorithm and the kernel transformation matrix is performed using only a fixed shifter.

4. The data processing device according to claim 1, wherein the target data is an image.

5. A data processing method in a data processing device that includes a neural network including convolution processing using a Winograd algorithm, the data processing method comprising:
acquiring target data to be processed; and
processing the target data using the neural network including the convolution processing,
wherein the data processing device calculates a Hadamard product of a result of kernel transformation processing based on the Winograd algorithm and a kernel transformation matrix when performing the convolution processing, and obtains a result of the convolution processing by using a calculation result of the Hadamard product for multiplication, and
wherein values of elements of the kernel transformation matrix are powers of 2 and have different constant values corresponding to divisors of division required for the kernel transformation processing when the kernel transformation matrix is not applied, and are set such that no division is included in the operation processing before the multiplication is executed.

6. A non-transitory storage medium storing a program executable by a computer including a neural network including convolution processing using a Winograd algorithm to perform data processing, the data processing comprising:
acquiring target data to be processed; and
processing the target data using the neural network including the convolution processing,
wherein a Hadamard product of a result of kernel transformation processing based on the Winograd algorithm and a kernel transformation matrix is calculated when performing the convolution processing, and a result of the convolution processing is obtained by using a calculation result of the Hadamard product for multiplication, and
wherein values of elements of the kernel transformation matrix are powers of 2 and have different constant values corresponding to divisors of division required for the kernel transformation processing when the kernel transformation matrix is not applied, and are set such that no division is included in the operation processing before the multiplication is executed.
